(19) United States
(12) Patent Application Publication
(10) Pub. No.: US 2023/0373672 A1
(43) Pub. Date: Nov. 23, 2023

(54) INSULATING PANEL AND APPARATUS FOR AND METHOD OF MANUFACTURING THE SAME

(71) Applicant: Packaging Technology Group, LLC, Fall River, MA (US)

(72) Inventors: William C. Blezard, Mattapoisett, MA (US); Marc Akouri, Fall River, MA (US); Devan Spellman, Acushnet, MA (US)

(21) Appl. No.: 18/319,787

(22) Filed: May 18, 2023

Related U.S. Application Data
(60) Provisional application No. 63/344,709, filed on May 23, 2022.

(51) Int. Cl. B65B 9/04; B65B 41/16; B65B 63/02; B65B 61/06; B65B 51/02

(52) U.S. Cl. CPC B65B 9/042; B65B 41/16; B65B 63/022; B65B 61/06; B65B 51/02

(57) ABSTRACT

A device for encapsulating a loose fill material includes a bottom portion defining an open top and a pair of open ends. A top portion is coupled to the bottom portion to provide a plenum space therebetween for encapsulating the loose fill material. The top portion includes a pair of enclosure ears that are adapted to close each of the open ends defined by the bottom portion.

### CROSS-REFERENCE TO RELATED APPLICATION

This application claims priority to and the benefit of U.S. Provisional Patent Application No. 63/344,709, titled “Insulating Panel and Apparatus for and Method of Manufacturing the Same” and filed on May 23, 2022, the entire contents of which are hereby incorporated by reference herein.

### TECHNICAL FIELD

This specification relates to insulating panels, as well as apparatuses and methods for manufacturing insulating panels.

### BACKGROUND

Shipping materials are often not biodegradable and are often required to be disposed of in landfills. Hence, there is an immediate need for recyclable shipping materials.

One conventional approach to producing shipping containers involves placing an insulating material (e.g., cellulose) between inner (or “product”) and outer boxes made of recyclable materials. In other instances, in which there is no inner (or “product”) box, the insulating material (e.g., cellulose) may be placed directly against the payload. Problematically, although cellulose is, itself, recyclable, a binder material that is not recyclable is often also included with the cellulose. Other times, an additional layer of material, either recyclable or non-recyclable, may be used to cover the major surfaces of the insulation material, but leaving the edges of the material exposed, allowing cellulose dust to enter the shipping container. Hence, it would be desirable to provide a system for fully encapsulating an insulating material that is fully recyclable.

### SUMMARY

Disclosed herein are improved insulating panels, apparatuses for manufacturing insulating panels, and techniques for manufacturing insulating panels.

At least one aspect of the present disclosure is directed to a device for encapsulating a loose fill material. The device includes a bottom portion defining an open top and a pair of open ends. A top portion is coupled to the bottom portion to provide a plenum space therebetween for encapsulating the loose fill material. The top portion includes a pair of enclosure ears that are adapted to close each of the open ends defined by the bottom portion.

Various embodiments of this aspect of the disclosure may include the following features. In some embodiments, the bottom portion has a U-shape. The bottom portion may include a base and a pair of walls that are substantially perpendicular to the base. For example, the bottom portion may include a bottom paper that is creased to form the base and the pair of walls. The pair of walls may run along a length of the bottom portion. In some embodiments, the pair of open ends defined by the bottom portion are along a width of the bottom portion. In some embodiments, the pair of enclosure ears are adhesively attached to the bottom portion.

In various embodiments, the device also includes the loose fill material. The loose fill material may be a cellulose material. In some embodiments, the top portion of the device includes a pair of flanges that extend beyond a width of the bottom portion. The pair of flanges may be configured to attach to at least one second device.

Another aspect of the present disclosure is directed to an apparatus for manufacturing a device that encapsulates a loose fill material. The apparatus includes a first infeed for delivering a first paper and a second infeed for delivering a second paper. A guide is structured and arranged to crease the first paper to form a pair of walls. A dispensing system dispenses the loose fill material between the pair of walls of the first paper. A first compression device couples the first paper to the second paper and a slicing mechanism cuts the first paper and the second paper to a desired length. An end closure device closes a pair of open ends of the first paper using portions of the second paper.

In some embodiments, the guide is configured to crease the first paper such that the pair of walls are substantially perpendicular to a base of the first paper. The end closure device may be configured to close the pair of open ends of the first paper by adhesively attaching the portions of the second paper to the first paper.

In various embodiments, the apparatus also includes a second compression device for compressing the loose fill material between the pair of walls of the first paper. The second compression device may be configured to compress the loose fill material to form a continuous bar of fill material. The slicing mechanism may be configured to cut the continuous bar of fill material to the desired length. In some embodiments, the loose fill material is a cellulose material.

Another aspect of the present disclosure is directed to a method of manufacturing a device that encapsulates a loose fill material. The method includes delivering a first paper and a second paper and creasing the first paper to form a pair of walls. A loose fill material is dispensed between the pair of walls of the first paper and the first paper is coupled to the second paper. The first paper and the second paper are cut to a desired length and a pair of open ends of the first paper are closed using portions of the second paper.

In some embodiments, the method also includes compressing the loose fill material between the pair of walls of the first paper to form a continuous bar of fill material and cutting the continuous bar of fill material to the desired length. In various embodiments, closing the pair of open ends of the first paper using portions of the second paper includes adhesively attaching the portions of the second paper to the first paper.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A shows a bottom perspective view of an insulating panel, in accordance with some embodiments described herein;

FIG. 1B shows a top perspective view of the insulating panel shown in FIG. 1A, in accordance with some embodiments described herein;

FIG. 2 shows a flow diagram of a method for manufacturing the insulating panel of FIG. 1A, in accordance with some embodiments described herein;

FIG. 3A shows an apparatus for manufacturing the insulating panel of FIG. 1A, in accordance with some embodiments described herein;

FIG. 3B shows a detailed view of the guide depicted in the apparatus of FIG. 3A, in accordance with some embodiments described herein;

FIG. 4 shows a flow diagram of a method for manufacturing the insulating panel of FIG. 1A, in accordance with some embodiments described herein;

FIG. 5A shows an apparatus for manufacturing the insulating panel of FIG. 1A, in accordance with some embodiments described herein;

FIG. 5B shows a detailed view of the guide depicted in the apparatus of FIG. 5A, in accordance with some embodiments described herein;

FIG. 6A shows a bottom perspective view of an insulating panel, in accordance with some embodiments described herein;

FIG. 6B shows a top perspective view of the insulating panel shown in FIG. 6A, in accordance with some embodiments described herein;

FIG. 7 shows a flow diagram of a method for manufacturing the insulating panel of FIG. 6A, in accordance with some embodiments described herein;

FIG. 8 shows an apparatus for manufacturing the insulating panel of FIG. 6A, in accordance with some embodiments described herein;

FIG. 9 shows a flow diagram of a method for manufacturing the insulating panel of FIG. 6A, in accordance with some embodiments described herein;

FIG. 10 shows an apparatus for manufacturing the insulating panel of FIG. 6A, in accordance with some embodiments described herein;

FIG. 11 shows a flow diagram of a method for manufacturing the insulating panel of FIG. 6A, in accordance with some embodiments described herein;

FIG. 12 shows an apparatus for manufacturing the insulating panel of FIG. 6A, in accordance with some embodiments described herein; and

FIG. 13 shows various techniques used to manufacture the insulting panel of FIG. 1A and the insulating panel of FIG. 6A, in accordance with some embodiments described herein.

### DETAILED DESCRIPTION

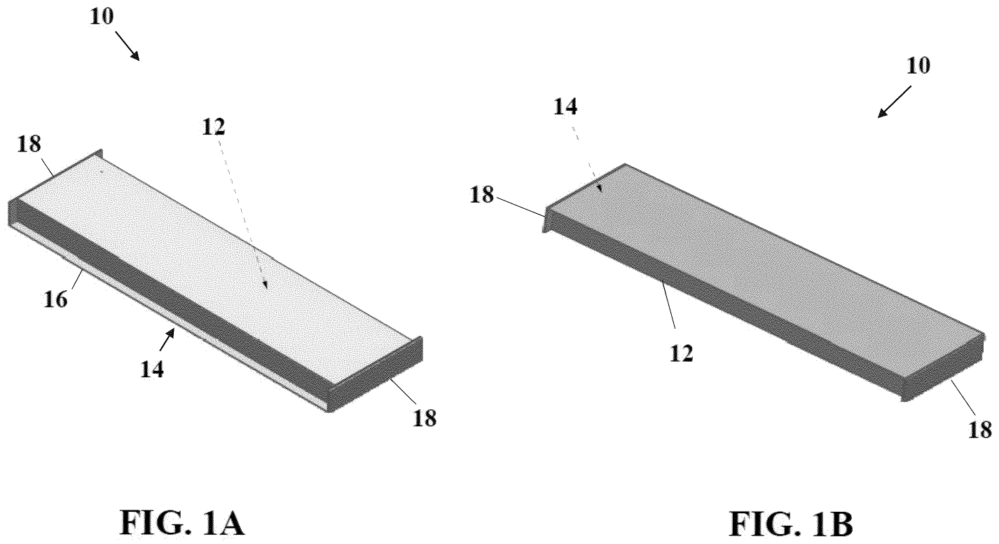

Referring to FIGS. 1A and 1B, an embodiment of an insulating panel 10 that is structured and arranged to encapsulate a cellulose or other organic filler material and, more specifically, to encapsulate the cellulose or other organic filler material within a paper shell is shown. In some embodiments, the panel 10 includes a bottom paper 12 and a top paper 14 that are attached to each other, creating an inner plenum space in which the cellulose filler or other organic filler material is encapsulated. The bottom paper 12 and the top paper 14 may be adhesively attached (e.g., glued) to each other. In some examples, the bottom paper 12 has a U-shape. In some examples, the bottom paper 12 includes a pair of walls that are substantially perpendicular to a base of the bottom paper 12. In some examples, the insulating panel 10 includes a top liner and/or a bottom liner. The top liner and/or the bottom liner may be used as a spine-like structure to promote overall strength and integrity of the panel 10. In some examples, the liners aid in forming 90 degree creases in the corners and edges of the outer paper shell (e.g., the bottom paper 12 or the top paper 14). In some examples, the liners improve the durability of the panel 10 by making the panel more resistant to puncturing. The liners can be made from organic, fibrous materials such as chip board, card stock, or thick/higher grade paper.

In some applications, the top paper 14 is dimensioned to have a larger length and width than the bottom paper 12. More particularly, the top paper 14 may be approximately ½ inch wider than the bottom paper 12 so as to provide, when the top 14 and bottom 12 paper are attached to one another, a flange 16. In some examples, the flange 16 is a ¼ inch flange. The length of the top paper 14 may also exceed that of the bottom paper 12 to form a plurality of (e.g., two) foldable ear portions 18 on either side of the panel 10. In some variations, the top paper 14 is manufactured to include creases to facilitate folding the pair of foldable ear portions 18 so that they can be attached (e.g., adhesively) to the bottom paper 12.

Advantageously, the paper of the panel 10 may be made with recyclable paper and glue, so that no plastic film or other polymer materials are used in the wrapper.

In certain embodiments, the insulating panel 10, when filled with a loose cellulose material, forms a continuous “bar” of cellulose of desired dimensions (e.g., length, width, and height). In some examples, the width can be up to 60 inches or more. The insulating panel 10 can be of any desired length. Advantageously, one insulating panel 10 can be wrapped and attached to a flange 16 of another insulating panel 10 and this may be done multiple times to create 4-sided insulation for parcel shippers. In such cases, there may be no need to adhere a separate protective flange to the outer corrugate of the parcel shipper, because the cellulose is already encompassed by paper.

Advantageously, the insulating panel 10 allows thicker insulation to be produced (e.g., 4 inches compared to 2 inches, in some instances). The ability to create very long insulating panels 10 means that one or more sides of a pallet shipper or pallet cover can be covered without the thermal breaks that result when multiple insulation panels abut one another. Embodiments described herein have the added benefit of not requiring binder materials such as polyester.

In certain embodiments, the insulating panel 10 is enclosed (or wrapped) on 4-6 sides by paper introduced as two separate feeds. In some examples, the first paper feed is formed into a U-shape and the second paper feed is sealed on top—or the second paper feed is wrapped around like a flow wrapping machine. In some examples, the first paper feed is creased to form a pair of walls that are substantially perpendicular to a base. In some embodiments, once the second paper feed is sealed or wrapped, two open ends are left on the insulting panel 10. The sealing of the two ends can be done in various ways, as is described below.

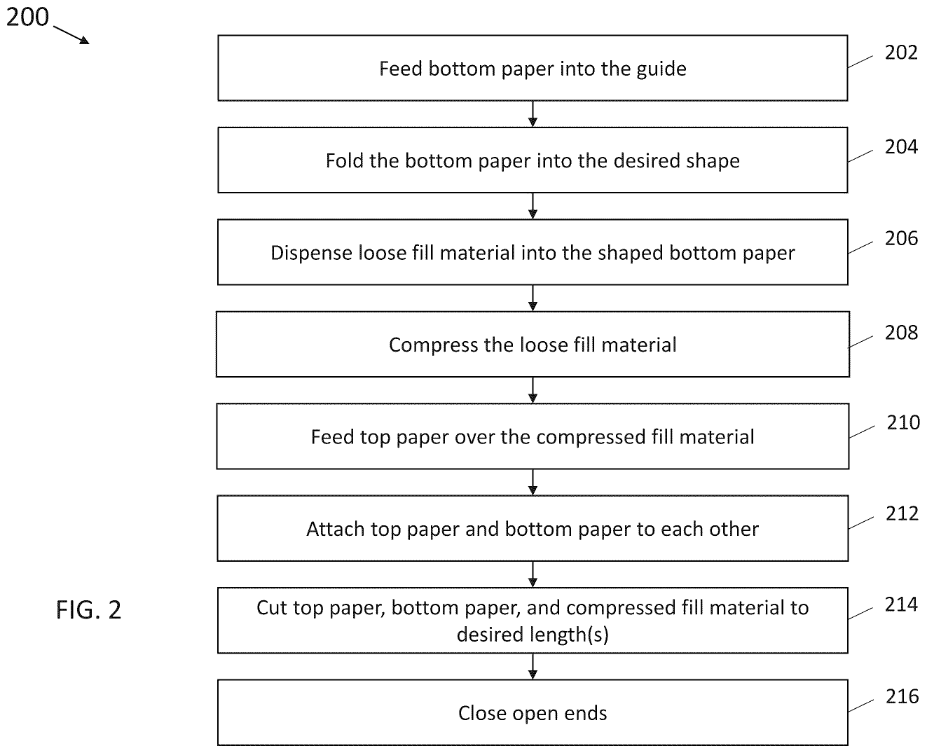

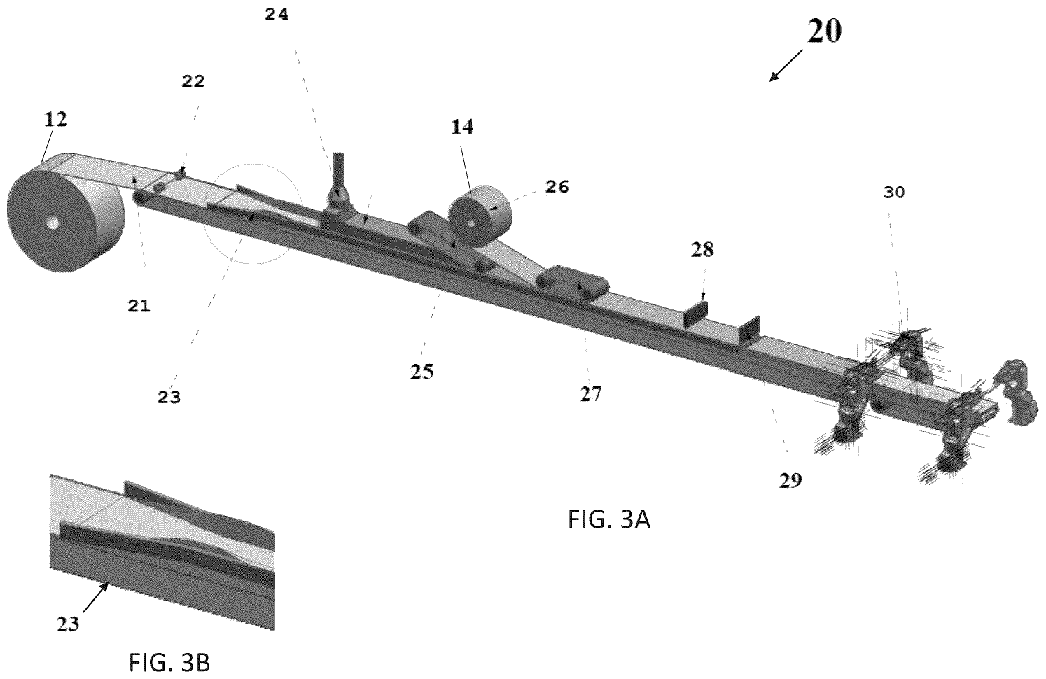

Having described an embodiment of an insulating panel 10, an exemplary method of manufacturing the insulating panel 10 will now be described. FIG. 2 illustrates a flow chart of a method 200 for manufacturing the insulating panel 10. FIG. 3A illustrates an apparatus 20 for manufacturing the insulating panel 10 described hereinabove. In some examples, the apparatus 20 includes: (a) a bottom paper infeed 21 adapted to provide bottom paper 12 and disposed at a proximal end of the apparatus 20; and (ii) a top paper infeed 26 adapted to provide top paper 14 and disposed approximately mid-span of the apparatus 20. Although the exemplary method of manufacturing the insulating panel 10 will refer to numerical steps, those of ordinary skill in the art can appreciate that the steps may take place concurrently or in a different order.

At step 202, the paper for the bottom paper 12 may be fed from the bottom paper infeed 21 into a metal guide 23. In some examples, the guide 23 is made from a non-metal material (e.g., plastic). Optionally, before entering the metal guide 23, the bottom paper 12 may pass through a paper pre-creasing roller 22, which is structured and arranged to pre-crease the bottom paper 12 at discrete locations. Advantageously, pre-creasing the bottom paper 12 facilitates folding the bottom paper 12 to create the shaped bottom paper 12.

At step 204, the bottom paper 12 is folded (or creased) into a desired shape. As shown in FIG. 3B, once the (e.g., pre-creased) bottom paper 12 enters the metal guide 23, a pair of walls are formed along the (e.g., pre-creased) opposing longitudinal edges of the bottom paper 12 (e.g., along a length of the bottom paper 12). The pair of walls may be substantially parallel to a base of the bottom paper 12. In some examples, the shaped bottom paper 12 has a U-shape. At step 206, the shaped bottom paper liner 12 then enters a loose cellulose dispensing system 24 and a loose cellulose compression conveyor 25, in which loose fill material is dispensed onto the folded paper. At step 208, the loose fill material is compressed by the compression conveyor 25 that is disposed above the channel. In some examples, the loose fill material is compressed to form a continuous bar of fill material.

At step 210, top paper 14 from the top paper infeed 26 may then be fed, so that the top paper 14 is positioned over the compressed fill material. In some examples, the top paper 14 is positioned such that there is an approximately ¼ inch flange (e.g., flange 16) extending beyond both walls of the shaped bottom paper 12. At step 212, the top paper 14 and the bottom paper 12 are attached to each other. For example, at a compression and heat station 27, compression and/or heat may be applied to the top 14 and bottom 12 papers, so as to attach (e.g., adhesively) the walls of the shaped bottom paper 12 to the top paper 14.

At step 214, the top paper 14, the bottom paper 12, and the compressed fill material are cut (or sliced) to desired lengths. In some examples, the bottom paper 12 and the compressed fill material are cut to the same length (e.g., with a slicing mechanism 29). The top paper 14 may be cut to a longer length (e.g., with the slicing mechanism 29), leaving extrusions that extend past the bottom paper 12 and the compressed fill material on both ends. In some examples, the extrusions may be creased (e.g., with a guillotine 28) to produce a pair of foldable ear pieces 18 prior to being cut by the slicing mechanism 29. Once the bottom paper 12 and the compressed fill material are cut to their desired length, a pair of open ends are defined by the bottom paper 12. In some examples, the pair of open ends are along a width of the bottom paper 12 (or the insulating panel 10).

At step 216, the open ends of insulating panel 10 are closed. By closing the open ends, the cut ends of the compressed fill material may be covered. In some examples, the open ends are closed by folding the ear pieces 18 to cover the exposed fill material. In some examples, the foldable ear pieces 18 are attached (e.g., adhesively) to the ends of the bottom paper 12. In some examples, robotic arms 30 may be provided to flip the completed panel 10 to facilitate attaching the pair of foldable ear pieces 18 to the ends of the bottom paper liner 12 to create the end closures.

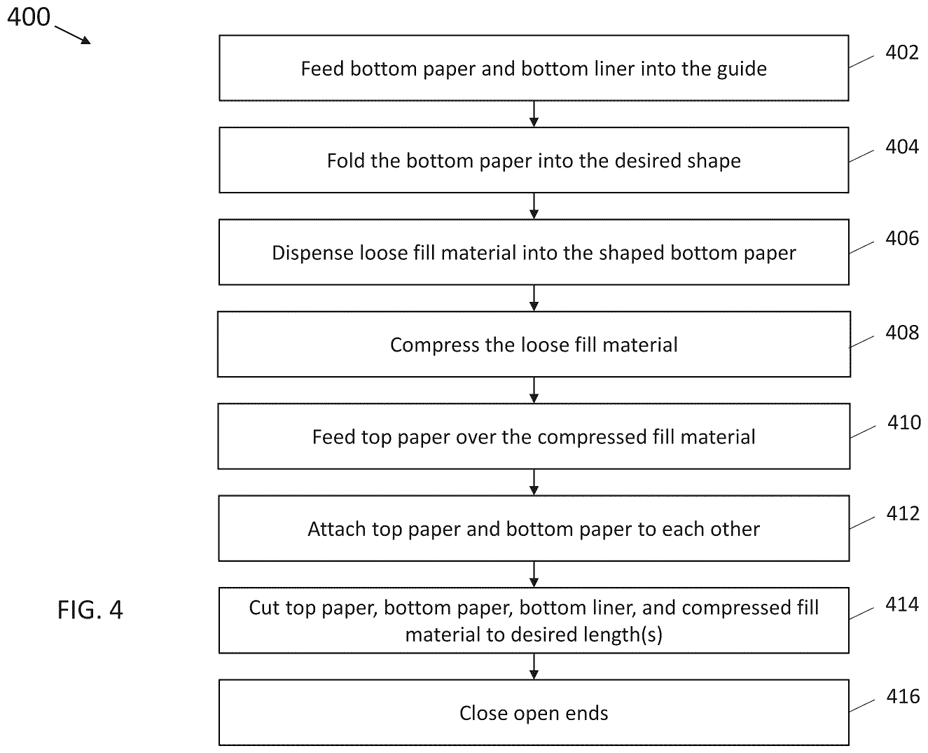

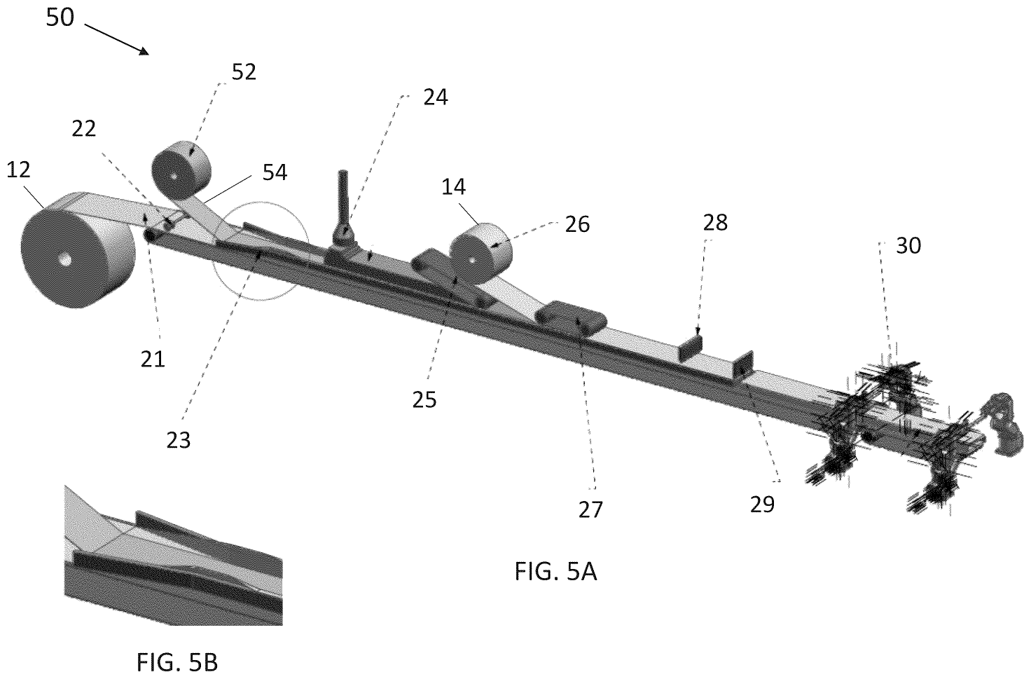

FIG. 4 illustrates a flow chart of another method 400 for manufacturing the insulating panel 10. In one example, the method 400 includes the addition of a bottom liner to the insulating panel 10. FIG. 5A illustrates an apparatus 50 for manufacturing the insulating panel 10 described hereinabove. In some examples, the apparatus 50 includes: (is) a bottom paper infeed 21 adapted to provide bottom paper 12 and disposed at a proximal end of the apparatus 50; (ii) a bottom liner infeed 52 adapted to provide a bottom liner 54; and (iii) a top paper infeed 26 adapted to provide top paper 14 and disposed approximately mid-span of the apparatus 20. Although the exemplary method of manufacturing the insulating panel 10 will refer to numerical steps, those of ordinary skill in the art can appreciate that the steps may take place concurrently or in a different order.

At step 402, the paper for the bottom paper 12 may be fed from the bottom paper infeed 21 into a metal guide 23. Optionally, before entering the metal guide 23, the bottom paper 12 may pass through a paper pre-creasing roller 22, which is structured and arranged to pre-crease the bottom paper 12 at discrete locations. Advantageously, pre-creasing the bottom paper 12 facilitates folding the bottom paper 12 to create the shaped bottom paper 12. In addition, the bottom liner 54 may be fed from the bottom liner infeed 52 into the metal guide 23. The bottom liner 54 is positioned on top of the bottom paper 12. In some examples, the bottom liner 54 has a smaller width than the bottom paper 12.

At step 404, the bottom paper 12 is folded (or creased) into a desired shape. As shown in FIG. 5B, once the (e.g., pre-creased) bottom paper 12 enters the metal guide 23, a pair of walls are formed along the (e.g., pre-creased) opposing longitudinal edges of the bottom paper 12 (e.g., along a length of the bottom paper 12). The pair of walls may be substantially parallel to a base of the bottom paper 12. In some examples, the pair of walls are folded around the bottom liner 54. The base of the bottom paper 12 may have the same dimensions as the bottom liner 54. In some examples, the shaped bottom paper 12 has a U-shape. At step 406, the shaped bottom paper liner 12 then enters a loose cellulose dispensing system 24 and a loose cellulose compression conveyor 25, in which loose fill material is dispensed onto the folded paper (e.g., between the walls of the bottom paper 12 and on top of the bottom liner 54). At step 408, the loose fill material is compressed by the compression conveyor 25 that is disposed above the channel. In some examples, the loose fill material is compressed to form a continuous bar of fill material.

At step 410, top paper 14 from the top paper infeed 26 may then be fed, so that the top paper 14 is positioned over the compressed fill material. In some examples, the top paper 14 is positioned such that there is an approximately ¼ inch flange (e.g., flange 16) extending beyond both walls of the shaped bottom paper 12. At step 412, the top paper 14 and the bottom paper 12 are attached to each other. For example, at a compression and heat station 27, compression and/or heat may be applied to the top 14 and bottom 12 papers, so as to attach (e.g., adhesively) the walls of the shaped bottom paper 12 to the top paper 14.

At step 414, the top paper 14, the bottom paper 12, the bottom liner 54, and the compressed fill material are cut (or sliced) to desired lengths. In some examples, the bottom paper 12, the bottom liner 54, and the compressed fill material are cut to the same length (e.g., with a slicing mechanism 29). The top paper 14 may be cut to a longer length (e.g., with the slicing mechanism 29), leaving extrusions that extend past the bottom paper 12, the bottom liner 54, and the compressed fill material on both ends. In some examples, the extrusions may be creased (e.g., with a guillotine 28) to produce a pair of foldable ear pieces 18 prior to being cut by the slicing mechanism 29. Once the bottom paper 12, the bottom liner 54, and the compressed fill material are cut to their desired length, a pair of open ends are defined by the bottom paper 12. In some examples, the pair of open ends are along a width of the bottom paper 12 (or the insulating panel 10).

At step 416, the open ends of insulating panel 10 are closed. By closing the open ends, the cut ends of the compressed fill material may be covered. In some examples, the open ends are closed by folding the ear pieces 18 to cover the exposed fill material. In some examples, the foldable ear pieces 18 are attached (e.g., adhesively) to the ends of the bottom paper 12. In some examples, robotic arms 30 may be provided to flip the completed panel 10 to facilitate attaching the pair of foldable ear pieces 18 to the ends of the bottom paper liner 12 to create the end closures.

As described above, an insulating panel 10 may be formed from two separate papers (e.g., top paper 4 and a bottom paper 12) that are attached to each other. However, it should be appreciated that insulating panels may be formed using a single (or continuous) paper.

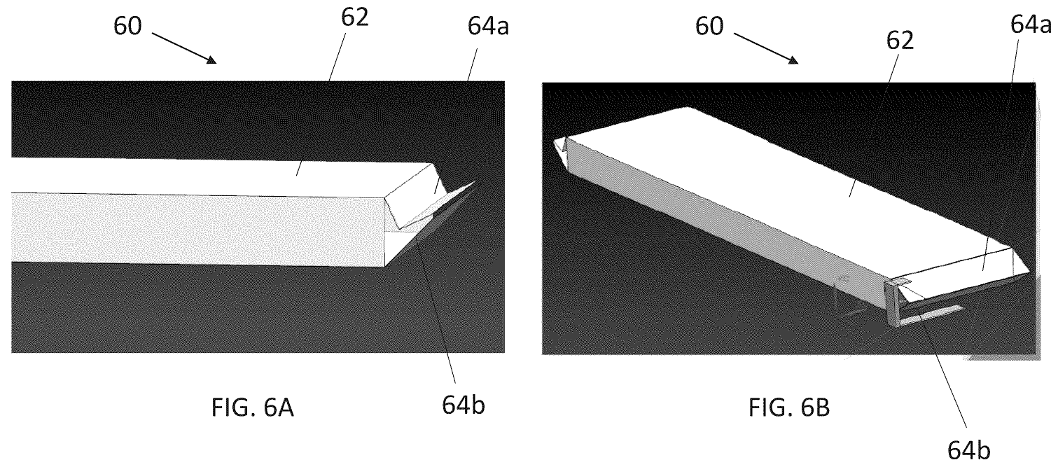

Referring to FIGS. 6A and 6B, an embodiment of an insulating panel 60 that is structured and arranged to encapsulate a cellulose or other organic filler material and, more specifically, to encapsulate the cellulose or other organic filler material within a paper shell is shown. In some embodiments, the panel 60 includes an outer paper 62 that is enclosed, creating an inner plenum space in which the cellulose filler or other organic filler material is encapsulated. A first edge of the outer paper 62 may be attached (e.g., adhesively) to a second edge of the outer paper to form the enclosed paper shell. As such, the outer paper 62 is wrapped around the cellulose filler to encapsulate the fill material.

In some examples, the outer paper 62 is cut to form a first foldable ear portion 64a and a second foldable ear portion 64b on both sides of the panel 60. In other words, each end of the panel 60 has a first foldable ear portion 64a and a second foldable ear portion 64b. In some variations, the outer paper 62 is manufactured to include creases to facilitate folding the ear portions 64a, 64b so that they can be attached (e.g., adhesively) to each other.

Advantageously, the paper of the panel 60 may be made with recyclable paper and glue, so that no plastic film or other polymer materials are used in the wrapper.

In certain embodiments, the insulating panel 60, when filled with a loose cellulose material, forms a continuous “bar” of cellulose of desired dimensions (e.g., length, width, and height). In some examples, the width can be up to 60 inches or more. The insulating panel 60 can be of any desired length. Advantageously, one insulating panel 60 can be attached to another insulating panel 60 and this may be done multiple times to create 4-sided insulation for parcel shippers.

Advantageously, the insulating panel 60 allows thicker insulation to be produced (e.g., 4 inches compared to 2 inches, in some instances). The ability to create very long insulating panels 60 means that one or more sides of a pallet shipper or pallet cover can be covered without the thermal breaks that result when multiple insulation panels abut one another. Embodiments of the invention have the added benefit of not requiring binder materials such as polyester.

In certain embodiments, the insulating panel 60 is enclosed (or wrapped) on 4-6 sides by paper introduced from one or more feeds. In some examples, the paper feed is formed into a U-shape before being overlapped to form the enclosed panel. In some embodiments, once the paper feed is sealed or wrapped, two open ends are left on the insulting panel 60. The sealing of the two ends can be done in various ways, as is described below.

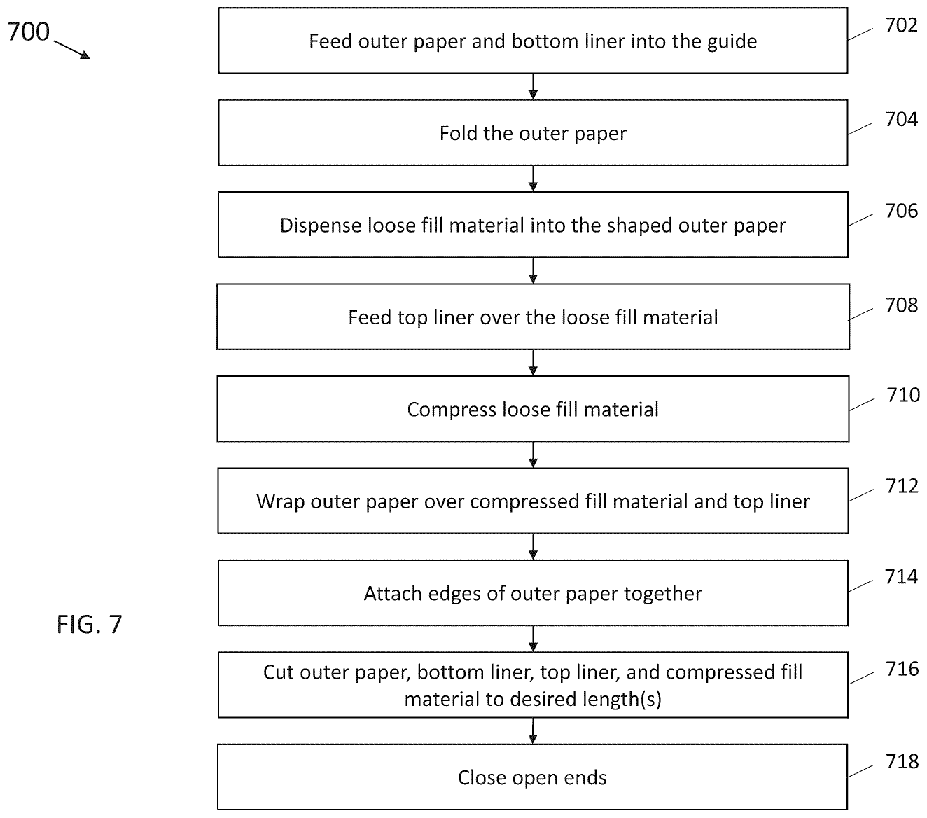

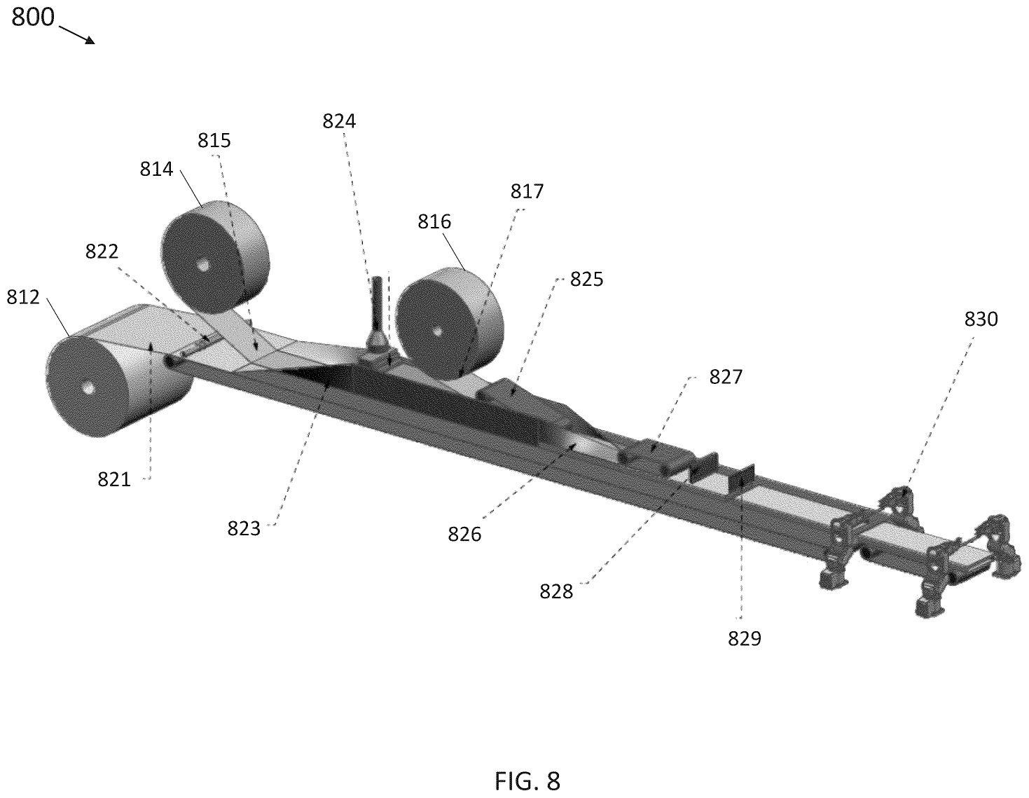

Having described an embodiment of an insulating panel 60, an exemplary method of manufacturing the insulating panel 60 will now be described. FIG. 7 illustrates a flow chart of a method 700 for manufacturing the insulating panel 60. In one example, the method 700 includes the addition of top and bottom liners to the insulating panel 60. FIG. 8 illustrates an apparatus 800 for manufacturing the insulating panel 60 described hereinabove. In some examples, the apparatus 800 includes: (i) an outer paper infeed 821 adapted to provide outer paper 812 and disposed at a proximal end of the apparatus 800; (ii) a bottom liner infeed 815 adapted to provide a bottom liner 814; and (iii) a top liner infeed 817 adapted to provide top liner 816 and disposed approximately mid-span of the apparatus 800. Although the exemplary method of manufacturing the insulating panel 60 will refer to numerical steps, those of ordinary skill in the art can appreciate that the steps may take place concurrently or in a different order.

At step 702, the paper for the outer paper 812 may be fed from the outer paper infeed 821 into a metal guide 823. Optionally, before entering the metal guide 823, the outer paper 812 may pass through a paper pre-creasing roller 822, which is structured and arranged to pre-crease the outer paper 812 at discrete locations. Advantageously, pre-creasing the outer paper 812 facilitates folding the outer paper 812 to create the shaped outer paper 812. In addition, the bottom liner 814 may be fed from the bottom liner infeed 815 into the metal guide 823. The bottom liner 814 is positioned on top of the outer paper 812. In some examples, the bottom liner 814 has a smaller width than the outer paper 812.

At step 704, the outer paper 812 is folded (or creased) into a desired shape. In some examples, once the (e.g., pre-creased) outer paper 812 enters the metal guide 823, a pair of walls are formed along the (e.g., pre-creased) opposing longitudinal edges of the outer paper 812 (e.g., along a length of the outer paper 812). The pair of walls may be substantially parallel to a base of the outer paper 812. In some examples, the pair of walls are folded around the bottom liner 814. The base of the outer paper 812 may have the same dimensions as the bottom liner 814. In other examples, the base of the outer paper 812 may have larger (e.g., wider) dimensions than the bottom liner 814. In some examples, the shaped outer paper 812 has a U-shape. At step 706, the shaped outer paper 812 then enters a loose cellulose dispensing system 824 in which loose fill material is dispensed onto the folded paper (e.g., between the walls of the outer paper 812 and on top of the bottom liner 814). At step 708, the top liner 816 may be fed from the top liner infeed 817 onto (or over) the dispensed fill material. The top liner 816 may have a smaller width than the outer paper 812. At step 710, the loose fill material is compressed by the compression conveyor 825 that is disposed above the channel. The compression conveyor 825 may compress the loose fill material by applying pressure and/or heat to the top liner 816. In some examples, the loose fill material is compressed to form a continuous bar of fill material.

At step 712, the outer paper 812, the bottom liner 814, the compressed fill material, and the top liner 816 are fed into a metal guide 826. The metal guide 826 is configured to fold the walls of the outer paper 812 such that they overlap and cover the compressed fill material and the top liner 816. At step 714, the overlapping edges of the outer paper 812 are attached to each other. For example, at a compression and heat station 827, compression and/or heat may be applied to the overlapping section of the outer paper 812, so as to attach (or seal) the edges of the outer paper 812.

At step 716, the outer paper 812, the bottom liner 814, the top liner 816, and the compressed fill material are cut (or sliced) to desired lengths. In some examples, the outer paper 812, the bottom liner 814, the top liner 816, and the compressed fill material are cut to the same length (e.g., with a slicing mechanism 829). The outer paper 812 may be cut to a longer length (e.g., with the slicing mechanism 829), leaving extrusions that extend past the bottom liner paper 814, the top liner 816, and the compressed fill material on both ends. In some examples, the extrusions may be creased (e.g., with a guillotine 828) to produce the pairs of foldable ear pieces 64a, 64b prior to being cut by the slicing mechanism 829. Once the outer paper 812, the bottom liner 814, the top liner 816, and the compressed fill material are cut to their desired length, a pair of open ends are defined by the outer paper 812. In some examples, the pair of open ends are along a width of the outer paper 812 (or the insulating panel 60).

At step 718, the open ends of insulating panel 60 are closed. By closing the open ends, the cut ends of the compressed fill material may be covered. In some examples, the open ends are closed by folding the ear pieces 64a, 64b to cover the exposed fill material. In some examples, the foldable ear pieces 64a, 64b are attached (e.g., adhesively) to each other. For example, at each end of the panel 60, the ear pieces 64a and 64b may be folded and attached to each other to close the respective open end. In some examples, robotic arms 830 may be provided to flip the completed panel 60 to facilitate attaching the pair of foldable ear pieces 64a, 64b to create the end closures.

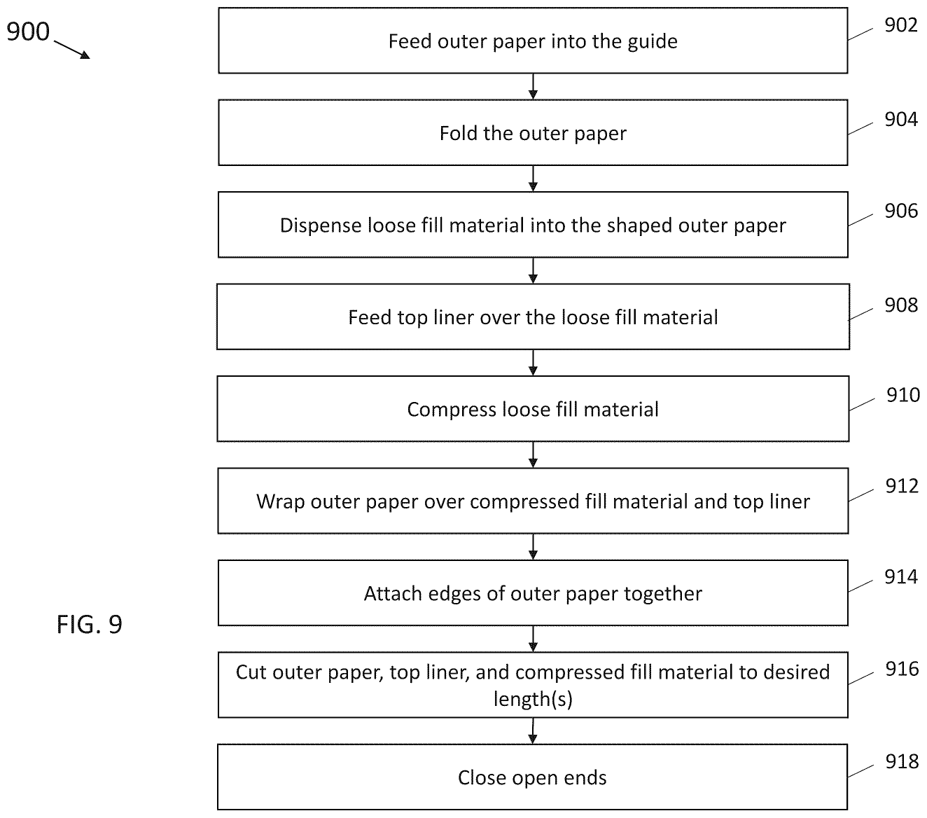

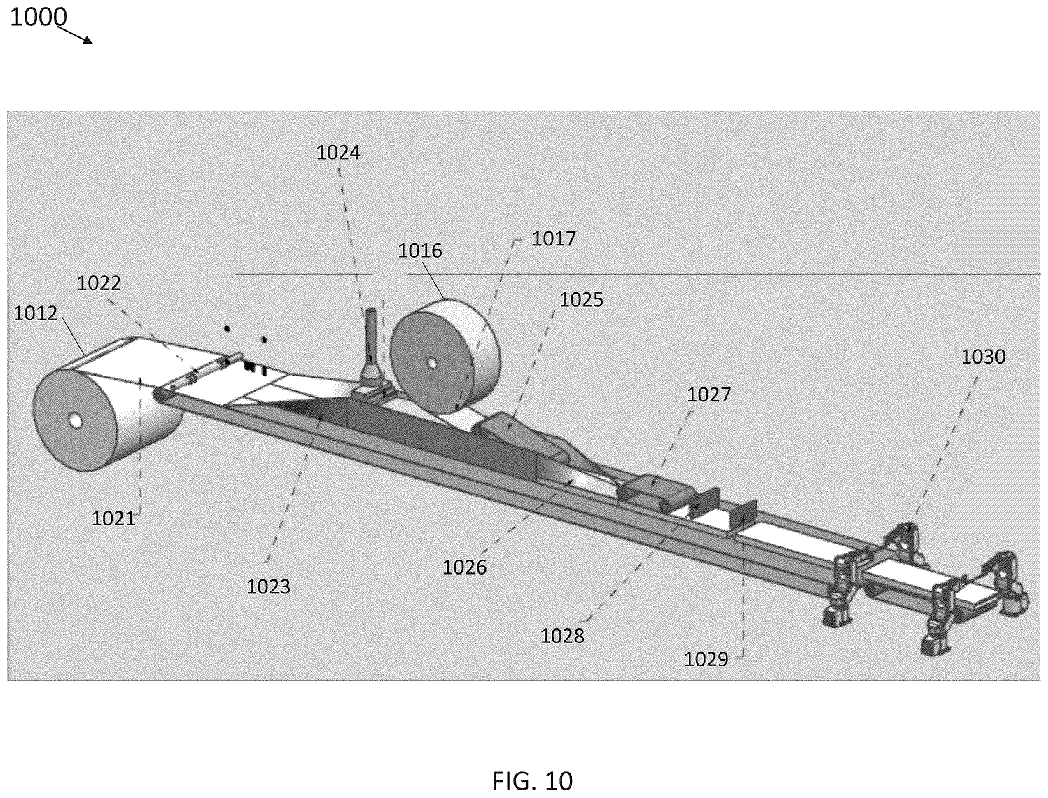

FIG. 9 illustrates a flow chart of another method 900 for manufacturing the insulating panel 60. In one example, the method 900 includes the addition of a top liner to the insulating panel 60. FIG. 10 illustrates an apparatus 1000 for manufacturing the insulating panel 60 described hereinabove. In some examples, the apparatus 1000 includes: (i) an outer paper infeed 1021 adapted to provide outer paper 1012 and disposed at a proximal end of the apparatus 1000; and (ii) a top liner infeed 1017 adapted to provide top liner 1016 and disposed approximately mid-span of the apparatus 1000. Although the exemplary method of manufacturing the insulating panel 60 will refer to numerical steps, those of ordinary skill in the art can appreciate that the steps may take place concurrently or in a different order.

At step 902, the paper for the outer paper 1012 may be fed from the outer paper infeed 1021 into a metal guide 1023. Optionally, before entering the metal guide 1023, the outer paper 1012 may pass through a paper pre-creasing roller 1022, which is structured and arranged to pre-crease the outer paper 1012 at discrete locations. Advantageously, pre-creasing the outer paper 1012 facilitates folding the outer paper 1012 to create the shaped outer paper 1012.

At step 904, the outer paper 1012 is folded (or creased) into a desired shape. In some examples, once the (e.g., pre-creased) outer paper 1012 enters the metal guide 1023, a pair of walls are formed along the (e.g., pre-creased) opposing longitudinal edges of the outer paper 1012 (e.g., along a length of the outer paper 1012). The pair of walls may be substantially parallel to a base of the outer paper 1012. In some examples, the shaped outer paper 1012 has a U-shape. At step 906, the shaped outer paper 1012 then enters a loose cellulose dispensing system 1024 in which loose fill material is dispensed onto the folded paper (e.g., between the walls of the outer paper 1012). At step 908, the top liner 1016 may be fed from the top liner infeed 1017 onto (or over) the dispensed fill material. In some examples, the top liner 1016 has a smaller width than the outer paper 1012. At step 910, the loose fill material is compressed by the compression conveyor 1025 that is disposed above the channel. The compression conveyor 1025 may compress the loose fill material by applying pressure and/or heat to the top liner 1016. In some examples, the loose fill material is compressed to form a continuous bar of fill material.

At step 912, the outer paper 1012, the compressed fill material, and the top liner 1016 are fed into a metal guide 1026. The metal guide 1026 is configured to fold the walls of the outer paper 1012 such that they overlap and cover the compressed fill material and the top liner 1016. At step 914, the overlapping edges of the outer paper 1012 are attached to each other. For example, at a compression and heat station 1027, compression and/or heat may be applied to the overlapping section of the outer paper 1012, so as to attach (or seal) the edges of the outer paper 1012.

At step 916, the outer paper 1012, the top liner 1016, and the compressed fill material are cut (or sliced) to desired lengths. In some examples, the outer paper 1012, the top liner 1016, and the compressed fill material are cut to the same length (e.g., with a slicing mechanism 1029). The outer paper 1012 may be cut to a longer length (e.g., with the slicing mechanism 1029), leaving extrusions that extend past the top liner 1016, and the compressed fill material on both ends. In some examples, the extrusions may be creased (e.g., with a guillotine 1028) to produce the pairs of foldable ear pieces 64a, 64b prior to being cut by the slicing mechanism 1029. Once the outer paper 1012, the top liner 1016, and the compressed fill material are cut to their desired length, a pair of open ends are defined by the outer paper 1012. In some examples, the pair of open ends are along a width of the outer paper 1012 (or the insulating panel 60).

At step 918, the open ends of insulating panel 60 are closed. By closing the open ends, the cut ends of the compressed fill material may be covered. In some examples, the open ends are closed by folding the ear pieces 64a, 64b to cover the exposed fill material. In some examples, the foldable ear pieces 64a, 64b are attached (e.g., adhesively) to each other. For example, at each end of the panel 60, the ear pieces 64a and 64b may be folded and attached to each other to close the respective open end. In some examples, robotic arms 1030 may be provided to flip the completed panel 60 to facilitate attaching the pair of foldable ear pieces 64a, 64b to create the end closures.

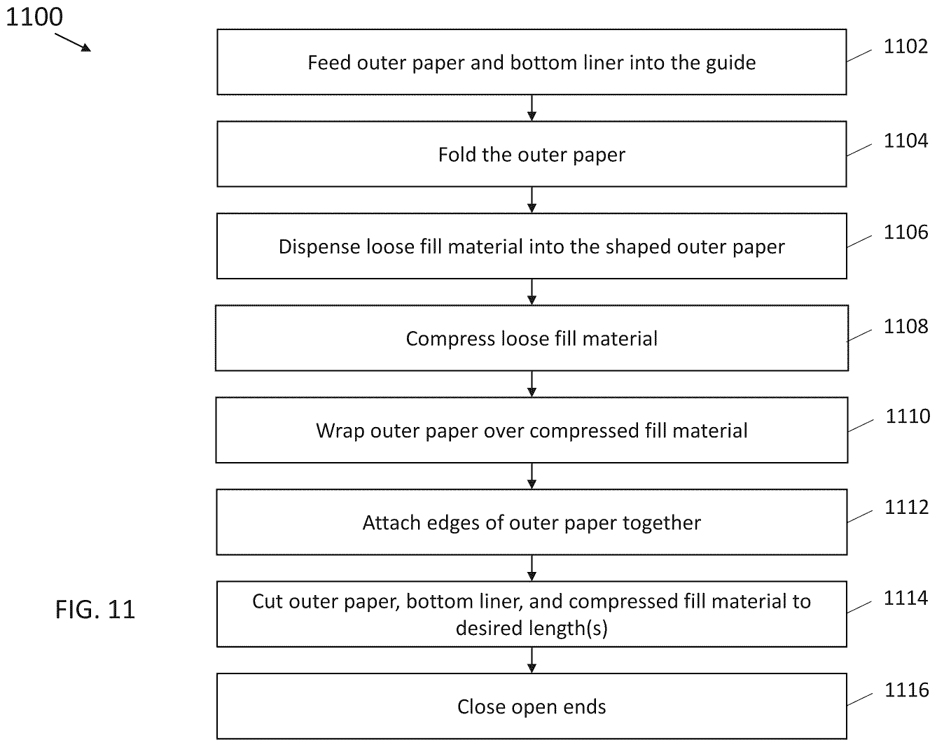

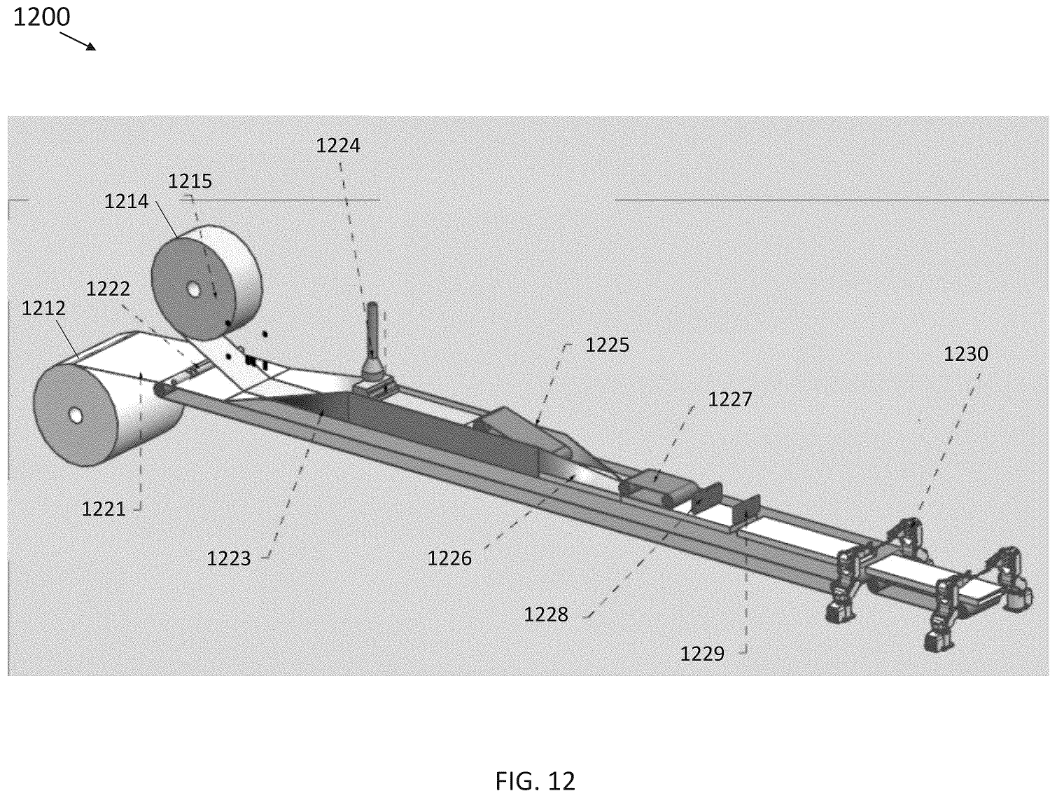

FIG. 11 illustrates a flow chart of another method 1100 for manufacturing the insulating panel 60. In one example, the method 1100 includes the addition of a bottom liner to the insulating panel 60. FIG. 12 illustrates an apparatus 1200 for manufacturing the insulating panel 60 described hereinabove. In some examples, the apparatus 1200 includes: (i) an outer paper infeed 1221 adapted to provide outer paper 1212 and disposed at a proximal end of the apparatus 1200; and (ii) a bottom liner infeed 1215 adapted to provide a bottom liner 1214. Although the exemplary method of manufacturing the insulating panel 60 will refer to numerical steps, those of ordinary skill in the art can appreciate that the steps may take place concurrently or in a different order.

At step 1102, the paper for the outer paper 1212 may be fed from the outer paper infeed 1221 into a metal guide 1223. Optionally, before entering the metal guide 1223, the outer paper 1212 may pass through a paper pre-creasing roller 1222, which is structured and arranged to pre-crease the outer paper 1212 at discrete locations. Advantageously, pre-creasing the outer paper 1212 facilitates folding the outer paper 1212 to create the shaped outer paper 1212. In addition, the bottom liner 1214 may be fed from the bottom liner infeed 1215 into the metal guide 1223. The bottom liner 1214 is positioned on top of the outer paper 1212. In some examples, the bottom liner 1214 has a smaller width than the outer paper 1212.

At step 1104, the outer paper 1212 is folded (or creased) into a desired shape. In some examples, once the (e.g., pre-creased) outer paper 1212 enters the metal guide 1223, a pair of walls are formed along the (e.g., pre-creased) opposing longitudinal edges of the outer paper 1212 (e.g., along a length of the outer paper 1212). The pair of walls may be substantially parallel to a base of the outer paper 1212. In some examples, the pair of walls are folded around the bottom liner 1214. The base of the outer paper 1212 may have the same dimensions as the bottom liner 1214. In other examples, the base of the outer paper 1214 may have larger (e.g., wider) dimensions than the bottom liner 1214. In some examples, the shaped outer paper 1212 has a U-shape. At step 1106, the shaped outer paper 1212 then enters a loose cellulose dispensing system 1224 in which loose fill material is dispensed onto the folded paper (e.g., between the walls of the outer paper 1212 and on top of the bottom liner 1214). At step 1108, the loose fill material is compressed by the compression conveyor 1225 that is disposed above the channel. In some examples, the loose fill material is compressed to form a continuous bar of fill material.

At step 1110, the outer paper 1212, the bottom liner 1214, and the compressed fill material are fed into a metal guide 1226. The metal guide 1226 is configured to fold the walls of the outer paper 1212 such that they overlap and cover the compressed fill material. At step 1112, the overlapping edges of the outer paper 1212 are attached to each other. For example, at a compression and heat station 1227, compression and/or heat may be applied to the overlapping section of the outer paper 1212, so as to attach (or seal) the edges of the outer paper 1212.

At step 1114, the outer paper 1212, the bottom liner 1214, and the compressed fill material are cut (or sliced) to desired lengths. In some examples, the outer paper 1212, the bottom liner 1214 and the compressed fill material are cut to the same length (e.g., with a slicing mechanism 1229). The outer paper 1212 may be cut to a longer length (e.g., with the slicing mechanism 1229), leaving extrusions that extend past the bottom liner paper 1214 and the compressed fill material on both ends. In some examples, the extrusions may be creased (e.g., with a guillotine 1228) to produce the pairs of foldable ear pieces 64a, 64b prior to being cut by the slicing mechanism 1229. Once the outer paper 1212, the bottom liner 1214, and the compressed fill material are cut to their desired length, a pair of open ends are defined by the outer paper 1212. In some examples, the pair of open ends are along a width of the outer paper 1212 (or the insulating panel 60).

At step 1116, the open ends of insulating panel 60 are closed. By closing the open ends, the cut ends of the compressed fill material may be covered. In some examples, the open ends are closed by folding the ear pieces 64a, 64b to cover the exposed fill material. In some examples, the foldable ear pieces 64a, 64b are attached (e.g., adhesively) to each other. For example, at each end of the panel 60, the ear pieces 64a and 64b may be folded and attached to each other to close the respective open end. In some examples, robotic arms 1230 may be provided to flip the completed panel 60 to facilitate attaching the pair of foldable ear pieces 64a, 64b to create the end closures.

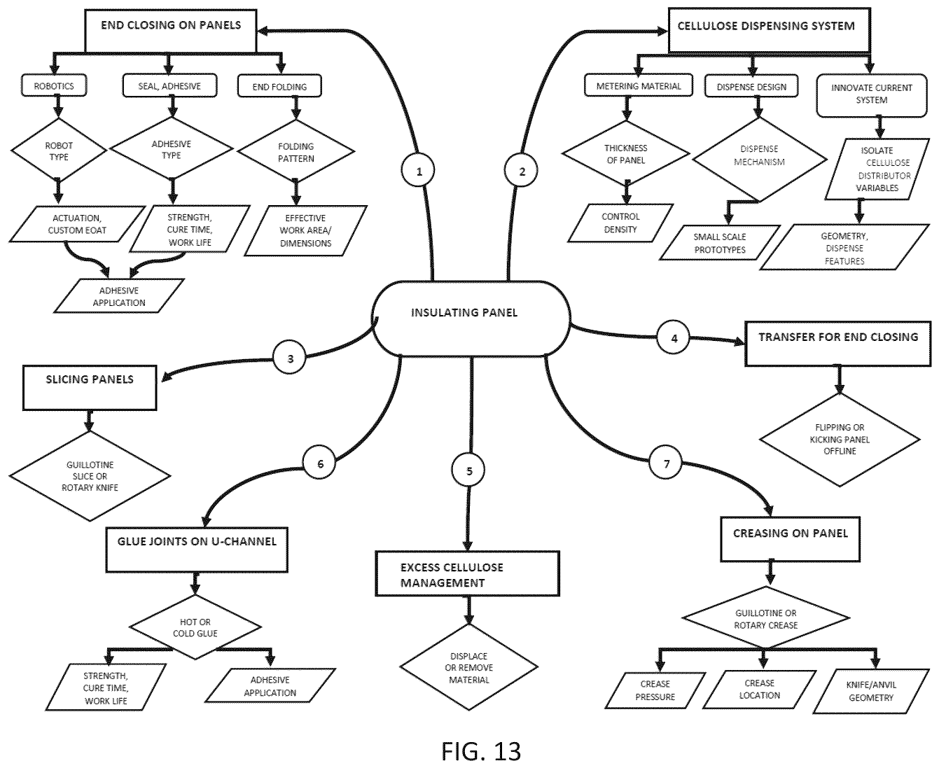

FIG. 13 is a diagram illustrating examples of techniques that may be used to manufacture the insulating panels described herein. For example, the techniques shown may be incorporated in the apparatuses 20, 50, 800, 1000, and 1200 used to manufacture the insulating panels 10 and 60.

In some examples, when creasing (or pre-creasing) the panels 10, 60, the various apparatuses may use guillotine devices or rotary crease devices. Such devices can be configured (or adjusted) based on desired crease pressure and crease location. In addition, the knife or anvil geometry of these devices may be selected based on the materials of the panels 10, 60 and/or the preferences of a user. The various apparatuses may include similar devices for the slicing (or cutting) of the panels 10, 60.

In some examples, the various apparatuses may use glue to strengthen or support joints of the panels 10, 60. For example, glue may be used to support the folded walls of the panels (e.g., forming the U-shape of the panel). In such examples, hot or cold glue may be applied to the panels 10, 60. In some examples, the type of glue may be selected based on strength, cure time, and work life (e.g., effective length) of the glue. It should be appreciated that glue may be used for any of the adhesive applications described herein.

The apparatuses may utilize different cellulose dispensing systems based on the configuration (or application) of the panels 10, 60. In some examples, the cellulose dispensing system includes a metering device that is used to regulate the dispensing of the loose fill material. For example, the metering device may control the density of the dispended material in order to control the thickness of the panels 10, 60. Likewise, the cellulose dispensing system may include an excess management system to displace or remove unwanted material (e.g., to control the panel thickness).

In some examples, the various apparatuses may utilize different techniques for closing the open ends of the panels 10, 60. For example, each apparatus may use robotics (e.g., actuators, end-of-arm tooling, etc.) to close the ends of the panels. In some examples, the robotics are configured to re-position the panel (e.g., flip over) before the open ends are closed. The robotics may be used to fold portions of the panel (e.g., foldable ears) to close the open ends. In some examples, the robotics are configured to fold the foldable ears in accordance with a folding pattern. The robotics may be used to apply adhesives (e.g., to the foldable ears) to close or seal the open ends.

Particular embodiments of the subject matter have been described. Other embodiments are within the scope of the following claims. The steps recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

What is claimed is:

1. A device for encapsulating a loose fill material, the device comprising:
a bottom portion defining an open top and a pair of open ends; and
a top portion coupled to the bottom portion to provide a plenum space therebetween for encapsulating the loose fill material,
wherein the top portion comprises a pair of enclosure ears that are adapted to close each of the open ends defined by the bottom portion.

2. The device of claim 1, wherein the bottom portion comprises a U-shape.

3. The device of claim 1, wherein the bottom portion comprises a base and a pair of walls that are substantially perpendicular to the base.

4. The device of claim 3, wherein the bottom portion comprises a bottom paper that is creased to form the base and the pair of walls.

5. The device of claim 3, wherein the pair of walls run along a length of the bottom portion.

6. The device of claim 1, wherein the pair of open ends defined by the bottom portion are along a width of the bottom portion.

7. The device of claim 1, wherein the pair of enclosure ears are adhesively attached to the bottom portion.

8. The device of claim 1, further comprising the loose fill material and wherein the loose fill material comprises a cellulose material.

9. The device of claim 1, wherein the top portion comprises a pair of flanges that extend beyond a width of the bottom portion.

10. The device of claim 9, wherein the pair of flanges are configured to attach to at least one second device.

11. An apparatus for manufacturing a device that encapsulates a loose fill material, the apparatus comprising:
a first infeed for delivering a first paper;
a second infeed for delivering a second paper;
a guide structured and arranged to crease the first paper to form a pair of walls;
a dispensing system for dispensing the loose fill material between the pair of walls of the first paper;
a first compression device for coupling the first paper to the second paper;
a slicing mechanism for cutting the first paper and the second paper to a desired length; and
an end closure device for closing a pair of open ends of the first paper using portions of the second paper.

12. The apparatus of claim 11, wherein the guide is configured to crease the first paper such that the pair of walls are substantially perpendicular to a base of the first paper.

13. The apparatus of claim 11, wherein the end closure device is configured to close the pair of open ends of the first paper by adhesively attaching the portions of the second paper to the first paper.

14. The apparatus of claim 11, further comprising:
a second compression device for compressing the loose fill material between the pair of walls of the first paper.

15. The apparatus of claim 14, wherein the second compression device is configured to compress the loose fill material to form a continuous bar of fill material.

16. The apparatus of claim 15, wherein the slicing mechanism is configured to cut the continuous bar of fill material to the desired length.

17. The apparatus of claim 11, wherein the loose fill material comprises a cellulose material.

18. A method of manufacturing a device that encapsulates a loose fill material, the method comprising:
delivering a first paper and a second paper;
creasing the first paper to form a pair of walls;
dispensing the loose fill material between the pair of walls of the first paper;
coupling the first paper to the second paper;
cutting the first paper and the second paper to a desired length; and
closing a pair of open ends of the first paper using portions of the second paper.

19. The method of claim 18, further comprising:
compressing the loose fill material between the pair of walls of the first paper to form a continuous bar of fill material; and
cutting the continuous bar of fill material to the desired length.

20. The method of claim 19, wherein closing the pair of open ends of the first paper using portions of the second paper comprises adhesively attaching the portions of the second paper to the first paper.
